(19) United States
(12) Patent Application Publication
(10) Pub. No.: US 2023/0130503 A1
(43) Pub. Date: Apr. 27, 2023

(54) Service Request Prioritization

(71) Applicant: CERNER INNOVATION, INC., Kansas City, KS (US)

(72) Inventors: Pramod Kumar Deshpande, Bengaluru (IN); Shishir Gupta, Bangalore (IN); Guru Shankar, Bengaluru (IN)

(21) Appl. No.: 17/509,430

(22) Filed: Oct. 25, 2021

(51) Int. Cl. G06Q 10/06

(52) U.S. Cl. CPC G06Q 10/063112

(57) ABSTRACT

Technologies are provided for automatically prioritizing service requests (e.g., trouble tickets). More particularly, embodiments of the present invention automatically and dynamically order the tickets in the associates' queues to ensure multiple KPI objectives are met. To do so, several inputs are initially received at a prioritization engine. The inputs may comprise associate details, client inputs, ticket details, and KPI details. The inputs are processed by the prioritization engine to allocate the tickets to one or more associates. The prioritization engine automatically determines the priority of each ticket assigned to each associate. A prioritized list of tickets assigned to each associate is provided to a user interface.

### BACKGROUND

Support services teams supporting large organizations typically receive hundreds of thousands of service requests annually. These service request may originate from hundreds or thousands of clients and may be routed to and/or resolved by hundreds or thousands of associates. At any given point in time, there may be tens of thousands of tickets residing in the ticket queues of the associates. By way of example, an average queue size per service associate may be thirty tickets belonging to various clients across geographies. However, each associate may only be able to service a portion of the tickets in the queue each day.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to prioritizing service requests (e.g., trouble tickets). More particularly, embodiments of the present invention automatically and dynamically order the tickets in the associates' queues to ensure multiple KPI objectives are met. To do so, several inputs are initially received at a prioritization engine. The inputs may comprise associate details, client inputs, ticket details, and KPI details. The inputs are processed by the prioritization engine to allocate the tickets to one or more associates. The prioritization engine automatically determines the priority of each ticket assigned to each associate. A user interface is generated by the prioritization engine that displays each ticket assigned to an associate and its priority.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present disclosure;

FIG. 2 is a block diagram of an exemplary system for providing service request prioritization, in accordance with an embodiment of the present disclosure;

FIG. 3 is a block diagram of an exemplary implementation of a prioritization engine, in accordance with some embodiments of the present disclosure;

FIG. 4 depicts a flow diagram showing an exemplary method corresponding to the inputs, processing, and output phases of the service request prioritization system, in accordance with various embodiments of the present disclosure;

FIG. 5 depicts an illustrative screen display of the service request prioritization user interface, in accordance with various embodiments of the present disclosure; and

FIG. 6 depicts a flow diagram showing an exemplary method of service request prioritization, in accordance with various embodiments of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

As noted in the Background, Support services teams supporting large organizations typically receive hundreds of thousands of service requests annually. These service request may originate from hundreds or thousands of clients and may be routed to and/or resolved by hundreds or thousands of associates. At any given point in time, there may be tens of thousands of tickets residing in the ticket queues of the associates. By way of example, an average queue size per service associate may be thirty tickets belonging to various clients across geographies. However, each associate may only be able to service a portion of the tickets in the queue each day.

The order in which each associate works on these tickets is critical to the performance of the service operation, which may be defined by various key performance indicators (KPIs). For example, the frequency of response on a particular ticket, the age of the ticket, the risk of service level agreement (SLA) breach, a focus on escalated tickets, the percentage of tickets resolved within the first twenty-four hours, and/or a twenty-four hour response to every inbound communication may be KPIs that are utilized to measure the performance of the service operation. Although conventional systems may provide SLA information to the associate, if the associate only relies upon the SLA information, the overall KPIs of the service operation may suffer.

Conventional systems struggle to maximize the support operation's performance across all KPIs. For instance, if an associate only focuses on resolving an issue, without keeping the client informed in a timely manner, the client may escalate the issue due to a lack of communication. On the other hand, if an associate only focuses on regular communication, the associate may be unable to work on a particular issue for a sustained period and the ticket may not get resolved. Similarly, if an associate only focuses on meeting SLAs, the aging ticket backlog might start increasing. Finally, if an associate only focuses on aging tickets, newer tickets may suffer from non-responsiveness and may attract negative survey returns. Moreover, one or more KPI objectives for a particular client may be well above a particular threshold while the same one or more KPI objectives for a different client may be at or below the threshold. In each of these examples, conventional systems fail to ensure all KPI objectives are met and fail to ensure KPI objectives for more than one client are maximized and/or maintained above a particular threshold.

To further illustrate, consider a scenario where an associate has a queue of tickets that includes tickets for client A, client B, and client C. The time remaining to respond to tickets for client A may be less than the time remaining to respond to tickets for client B. Further the time remaining to respond to tickets for client B may be less than the time remaining to respond to tickets for client C. In conventional systems, the tickets for client A would be prioritized over the tickets for client B and client C and the tickets for client B would be prioritized over the tickets for client C because of the time remaining to respond. However, current KPI objectives for clients A and B may indicate that tickets for clients A and B are being responded to more timely than tickets for client C. In this scenario, although the associate may resolve the tickets for clients A and B in a timely manner, by doing so, the KPIs for client C may deteriorate below a particular threshold to the point that the SLA for client C is violated.

Embodiments of the present invention relate to prioritizing service requests (e.g., trouble tickets). More particularly, embodiments of the present invention automatically and dynamically order the tickets in the associates' queues to ensure multiple KPI objectives are met. To do so, several inputs are initially received at a prioritization engine. The inputs may comprise associate details, client inputs, ticket details, and KPI details. The inputs are processed by the prioritization engine to allocate the tickets to one or more associates. The prioritization engine automatically determines the priority of each ticket assigned to each associate. The output of the prioritization engine is pushed to that displays each ticket assigned to an associate and its priority.

In order to ensure that the priority of the tickets is followed, each ticket is attached with a reward score and a penalty score. Various tickets, based on which KPI objective may be impacted, receive a different reward score or penalty score. For example, if a particular KPI objective is more at-risk, the reward score may be higher if the KPI objective is met. Conversely, the penalty score may be more severe if the KPI objective is not met. Aggregate scores corresponding to rewards and penalties may be published by the prioritization engine to the user interface on a regular interval (e.g., daily) so performance of each associate can be tracked. In this way, the aggregate scores correspond to an adherence to the priority for the tickets assigned to the associates. KPI performance feedback may be based on the aggregate score and may be utilized by the prioritization as part of a feedback loop to influence future allocation and prioritization of tickets in the queue.

In embodiments, the prioritization system leverages machine learning to automatically predict if a particular KPI objective is in danger of falling below a particular threshold for a particular client. In response, the prioritization system may automatically adjust weights to the rewards or penalties to prevent the particular KPI objective from falling below the threshold. The weights to the rewards or penalties can be adjusted on an individual client basis or universally across all clients, as appropriate. Similarly, in embodiments, the prioritization system leverages machine learning to automatically predict if a particular associate is in danger of letting a particular KPI objective fall below a particular threshold for a particular client. In response, the prioritization system may automatically adjust weights to the rewards or penalties for the particular associate to prevent associate from letting the KPI objective fall below the threshold. The weights to the rewards or penalties can be adjusted on an individual associate basis, for the particular client, or for all clients being serviced by the associate, as appropriate.

Accordingly, in one aspect, an embodiment of the present invention is directed to a method. The method includes receiving, at a prioritization engine, one or more inputs comprising associate details, client inputs, ticket details, and key performance indicator (KPI) details, the one or more tickets corresponding to a plurality of tickets in a queue. The method also comprises processing, by the prioritization engine, the one or more inputs to allocate the plurality of tickets to one or more associates. The method further comprises automatically determining, by the prioritization engine, the priority of each ticket of the plurality of tickets for each associate of the one or more associates. The method provides a prioritized list of tickets assigned to an associate of the one or more associates to a user interface.

In another aspect of the invention, an embodiment is directed to one or more computer storage media having computer-executable instructions embodied thereon that, when executed by a computer, causes the computer to perform operations. The operations comprise receiving, at a prioritization engine, one or more inputs comprising associate details, client inputs, ticket details, and key performance indicator (KPI) details, the one or more tickets corresponding to a plurality of tickets in a queue. The operations also comprise processing, by the prioritization engine, the one or more inputs to allocate the plurality of tickets to one or more associates. The operations further comprise automatically determining, by the prioritization engine, the priority of each ticket of the plurality of tickets for each associate of the one or more associates. The operations also comprise providing, by the prioritization engine, a prioritized list of tickets assigned to an associate of the one or more associates to a user interface.

In a further aspect, an embodiment is directed to a system that includes one or more processors and a non-transitory computer storage medium storing computer-useable instructions that, when used by the one or more processors, cause the one or more processors to: receive one or more inputs comprising associate details, client inputs, ticket details, and key performance indicator (KPI) details, the one or more tickets corresponding to a plurality of tickets in a queue; process the one or more inputs to allocate the plurality of tickets to one or more associates; automatically determine the priority of each ticket of the plurality of tickets for each associate of the one or more associates; and provide a prioritized list of tickets assigned to an associate of the one or more associates to a user interface.

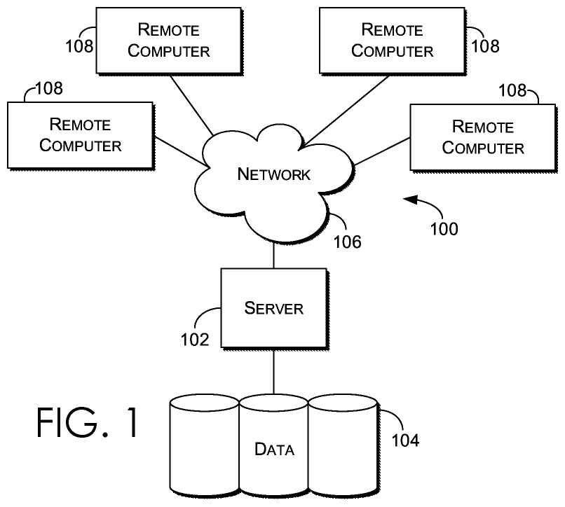

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Computer storage media does not include signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, ambulatory settings, medical billing and financial offices, hospital administration settings, home healthcare environments, clinicians' offices, Center for Disease Control, Centers for Medicare & Medicaid Services, World Health Organization, any governing body either foreign or domestic, Health Information Exchange, and any healthcare/government regulatory bodies not otherwise mentioned. The remote computers 108 might also be physically located in nontraditional medical care environments so that the entire healthcare community might be capable of integration on the network. In various embodiments, the remote computers 108 may represent clients or infrastructure of a client (e.g., devices, applications, services, and the like) or the remote computers 108 may represent user devices corresponding to a support team. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

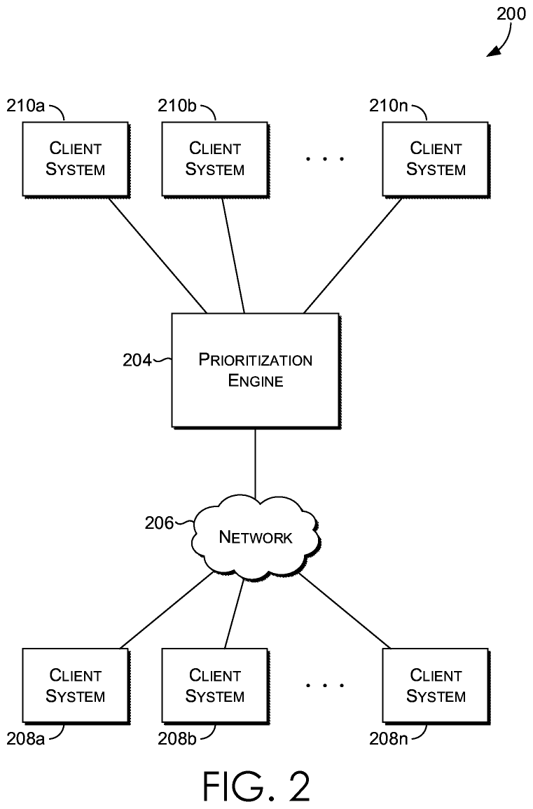

Turning now to FIG. 2, a service request prioritization system 200 is depicted suitable for use in implementing embodiments of the present invention. The service request prioritization system 200 is merely an example of one suitable computing system environment and is not intended to suggest any limitation as to the scope of use or functionality of embodiments of the present invention. Neither should the service request prioritization system 200 be interpreted as having any dependency or requirement related to any single module/component or combination of modules/components illustrated therein.

The service request prioritization system 200 includes prioritization engine 204, client systems 208a-208n, and associate devices 210a-210n, and may be in communication with one another via a network 206. The network 206 may include, without limitation, one or more secure local area networks (LANs) or wide area networks (WANs). The network 206 may be a secure network associated with a facility such as a healthcare facility. Each healthcare facility may have an information technology infrastructure comprising client systems (e.g., 208a, 208b, or 208n) supported by a support service team via associated devices 210a-210n. The secure network may require that a user log in and be authenticated in order to send and/or receive information over the network 206.

The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, prioritization engine 204 might reside on a server, cluster of servers, or a computing device remote from one or more of the remaining components. Although illustrated as separate systems, the functionality provided by each of these components might be provided as a single component/module. The single unit depictions are meant for clarity, not to limit the scope of embodiments in any form.

Components of the service request prioritization system 200 may include a processing unit, internal system memory, and a suitable system bus for coupling various system components, including one or more data stores for storing information (e.g., files and metadata associated therewith). Components of the service request prioritization system 200 typically includes, or has access to, a variety of computer-readable media.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Prioritization engine 204 includes or has access to infrastructure that is capable of receiving, for example, information from client systems 208a-208n. The information received in association with prioritization engine 204 may comprise service requests. For example, client may submit a service request (e.g., a trouble ticket or ticket) via client system 208a-208n that corresponds to an incident, or a situation where something is not working properly within the client infrastructure and a client is requesting the issue be fixed. In another example, client may submit a service request via client system 208-208n that corresponds to a configuration ticket, or a situation where the client is asking that something within the client infrastructure be configured in a certain way (e.g., they want a new drop down in a user interface for a new medication).

Generally, the prioritization engine 204 is configured to receive one or more tickets that have been submitted to a queue or identify newly logged tickets that have entered the queue. For example, the prioritization engine 204 may execute a batch job that runs regularly (e.g., every 5 minutes) to identify newly logged tickets by querying a ticket database or queue. Once received or identified, the smart routing engine routes the ticket to the appropriate support team.

Support team generally provides support services and resolution for client systems 208a-208n in response to service request received by prioritization engine 204 and routed to the appropriate support team. Each support team comprises a number of associate devices corresponding to associates of a particular support team. The associates interact with the service requests via the associate devices to provide the requested services or resolution at client systems 208a-208n on behalf of clients.

Associate devices 210a-210n may be any type of computing device used within a support services center or as part of a support team process to receive, display, communicate information to another user or system, configure or troubleshoot infrastructure corresponding to clients, or perform services on behalf of clients to address service requests. Associate devices 210a-210n may be capable of communicating via a network with prioritization engine 204, client systems 208a-208n, or the infrastructure of client systems 208a-208n. Such devices may include any type of mobile and portable devices including cellular telephones, personal digital assistants, tablet PCs, smart phones, and the like.

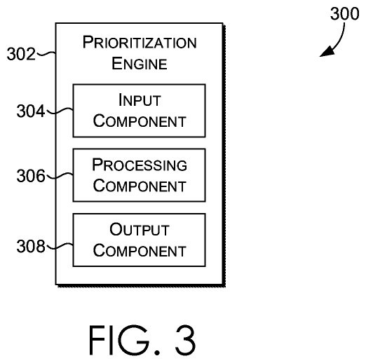

Referring now to FIG. 3, the prioritization engine 302 includes several components and generally provides a support system for one or more clients. For example, the prioritization engine 302 may include input component 304, processing component 306, and output component 308. Initially, the prioritization engine 302 receives service requests from one or more clients corresponding to one or more client systems. In embodiments, the prioritization engine 302 executes a regularly scheduled batch job (e.g., every 5 minutes) to identify all new tickets that have been received in the queue of the support system.

Input component 304 is generally configured to receive one or more inputs comprising associate details, client inputs, ticket details, and key performance indicator (KPI) details. The one or more inputs correspond to a plurality of tickets in the queue. Associate details may include information corresponding to the associates including shift information, vacation information, associate role and/or skill set, assignment to a particular client, and availability and/or capacity information. Each of these items may inform the prioritization engine as to which associates are actually working at a particular time, when an upcoming vacation may impact the availability of an associate, the ability or responsibility of the associate to work on a particular ticket type, or current availability and/or capacity of the associate to handle additional tickets.

Client inputs may include information regarding specific client information that may affect whether a particular support team and/or associate may be responsible for resolving tickets that originate with a specific client. For example, a support team and/or associate in a particular region may be responsible for tickets originating from that client or may be better situated to resolve the ticket (e.g., based on time zone, lack of language barriers, or other factors). Client inputs may also indicate whether a particular client is a focus client (or a client that for contractual or other reasons may be of particular importance, at least at the time the ticket is received). Client inputs may further include contract information that may define particular obligations for how a particular ticket is allocated and prioritized.

Ticket details may include information corresponding to a particular ticket such as ticket identification (ID), ticket type, ticket age, current ticket rank or priority, SLA details, SLA remaining, SLA clock, and/or entitlement. The ticket ID may simply be a numeric identifier that helps the support system track a particular ticket. The ticket type may categorize the ticket such as a restore request, a service request, an incident ticket, or a configuration request. Ticket age indicates how long a particular ticket has been pending. Current ticket rank or priority indicates the current priority of the ticket within the system. SLA details may indicate a contractual obligation defining a timeframe for resolving each particular type of ticket. SLA remaining indicates how much longer a particular ticket has left in the timeframe for resolving the particular type of ticket. SLA clock indicates whether the clock for the timeframe is currently running, delayed (e.g., waiting on the client), or stopped. Entitlement may indicate if the ticket corresponds to a particular client or entitlement that is inherently higher priority based on the client or entitlement. For example, an entitlement in the production environment would be much higher priority than an entitlement in the testing environment. Entitlement may also indicate the particular client has requested a focus on the particular system or asset within the client infrastructure. Each of these factors may be utilized by prioritization engine to automatically determine the priority of the ticket.

KPI details may include various KPIs along with a KPI-wise priority rank. For example, the KPIs may include a frequency of response, a ticket age, a risk of SLA breach, a focus on escalated tickets, a percentage of tickets resolved within the first twenty-four hours, a twenty-four hour response to every inbound communication, and the like. Each of these KPIs may also be ranked with respect to each other (e.g., at a system-wide level, at a client-specific level, etc.). KPI details may additionally include a reward and penalty scheme for all KPIs. In this way, various tickets, based on which KPI is impacted, may be attached with a different reward or penalty score. For example, the more at-risk the KPI, the higher the attached reward and the more severe the attached penalty to ensure associates adhere to the determined priority.

Processing component 306 generally processes the one or more inputs to allocate automatically determine the priority of each ticket of the plurality of tickets for each associate of the one or more associates. To do so, processing component 306 utilizes allocation logic on the one or more inputs. To illustrate, consider the allocation logic in Table 1, below:

TABLE 1
SR Prioritization

| Priority Seq | Description | Criteria |
|---|---|---|
| 1 | Escalation | <24 Hours Comm |
| 2 | NCLB | Associate Court |
| 3 | NCLB | Client Court |
| 4 | SLA | <24 Hours - Associate Court |
| 5 | SLA | <24 Hours - Client Court |
| 6 | SLA | 1-2 days - Associate Court |
| 7 | SLA | −2 to 0 days - Associate Court |
| 8 | Communication | 4 to 10 days - Client Court |
| 9 | SLA | 3 to 10 days - Associate Court |
| 10 | Communication | >10 days - Associate Court |
| 11 | Communication | >10 Days - Client Court |
| 12 | SLA | >10 days - Associate Court |
| 13 | SLA | <−2 days - Associate Court |
| 14 | Pending Tickets | Pending tickets >10 Days |

As shown, the tickets that have been escalated and are due for communication within the next twenty-four hours have the highest priority. Next, the tickets for clients depending on focused entitlement are given priority. Tickets that require associate action may be prioritized above tickets requiring client action. Since there may be penalties attached to failing to meet SLA obligations, the next priority is based on SLA details. For example, the tickets with less than twenty-four hours of SLA remaining and still requiring associate action may have higher priority than tickets with less than twenty-four hours of SLA remaining and waiting for client action. Additionally, the tickets requiring associate action that are within one to two days of SLA remaining may be prioritized over tickets that have recently missed the SLA by zero to two days.

The tickets that are waiting on a client action typically require follow-up to help get the necessary information or confirmation for closure of the ticket. For example, all tickets that are pending without any response from the client for four to ten days may be included as the next highest priority. Tickets requiring associate action with SLA remaining in the range of three to ten days are the next category to be prioritized. Finally, the tickets without any action for more than ten days are prioritized over tickets with SLA remaining of more than ten days and tickets with missed SLA.

Once the processing component applies the current allocation scheme to the tickets in the queue, the output component 308 generates a user interface that displays tickets of the plurality of tickets assigned to an associate of the one or more associates and indicates the priority of the tickets. In this way, the allocation scheme is displayed to each associate and enables each associate to meet KPIs without spending any time analyzing tickets that need to be resolved.

As the associate works on tickets in the associate queue, scoring logic determines KPI performance feedback for the tickets assigned to the associate. In this way, the associate receives penalties and rewards based on the adherence to the allocation scheme. In other words, if the associate fails to adhere to the allocation scheme and, in doing so, fails to meet a particular KPI objective, the scoring logic will penalize the associate in accordance with the penalty attached to the particular ticket. On the other hand, if the associate sticks to the allocation scheme and meets a particular KPI objective, the scoring logic will reward the associate in accordance with the reward attached to the particular ticket. At the end of a configurable time period (e.g., shift, day, week, etc.), the rewards and penalties are aggregated into an aggregate score.

In embodiments, the aggregate score may be displayed in the user interface and provided as KPI performance feedback. The KPI details received by the input component 304 may include the KPI performance feedback. Because the system includes KPI performance feedback, it can dynamically make adjustments to the allocation logic to ensure that the health of the KPIs across all clients is maintained. For example, if the KPI performance feedback indicates that a particular KPI objective or a KPI objective for a particular client is deteriorating, the prioritization engine 302 may dynamically adjust weights corresponding to the rewards or penalties or particular tickets within the queue. Similarly, the prioritization engine 302 may dynamically adjust the allocation logic to change how the tickets are allocated to the associates or how the priority is assigned to each of the tickets.

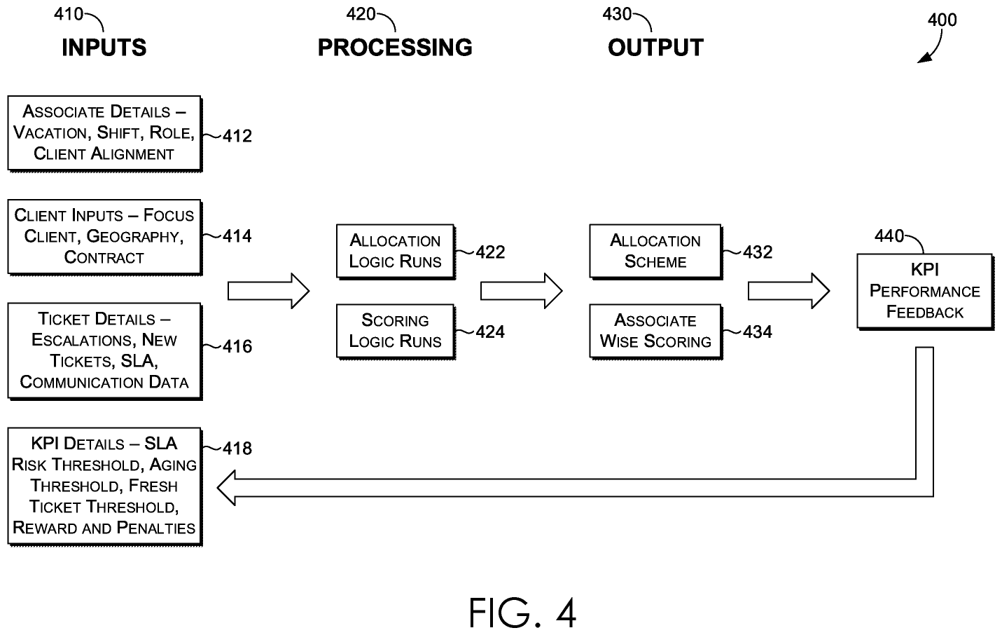

As shown in FIG. 4, a flow diagram is provided illustrating a method 400 corresponding to the inputs, processing, and output phases of the service request prioritization system, in accordance with various embodiments of the present disclosure. Method 400 may be performed by any computing device (such as computing device described with respect to FIG. 1) with access to a prioritization system (such as the one described with respect to FIG. 2) or by one or more components of the prioritization system (such as the prioritization engine described with respect to FIGS. 2 and 3).

Initially, in the input phase 410, various inputs are received. The inputs may include associate details 412 (e.g., vacation, shift, role, client alignment), client inputs 414 (e.g., focus client, geography, contract), ticket details 416 (e.g., escalations, new tickets, SLA, communication data), KPI details 418 (e.g., SLA risk threshold, aging threshold, fresh ticket threshold, rewards and penalties).

Next, in the processing phase 420, allocation logic 422 and scoring logic 424 runs. The allocation logic 422 allocates and prioritizes the tickets in the queue for the associates. The scoring logic 424 determines the rewards and penalties for each ticket an associate works on and aggregates them into an aggregate score.

In the output phase 430, the allocation scheme 432 provides the user interface with the tickets assigned to an associate as well as the priority of each ticket. The associate wise scoring 434 provides the user interface with the aggregate score for the associate.

Finally, the aggregate score can be utilized as KPI performance feedback 440 as part of a feedback loop that feeds back into the input phase 410 as part of the KPI details 418. The KPI performance feedback enables the prioritization system to dynamically adjust weights and penalties for tickets or the allocation logic, on the fly, to ensure that all KPI objectives are optimized across all clients.

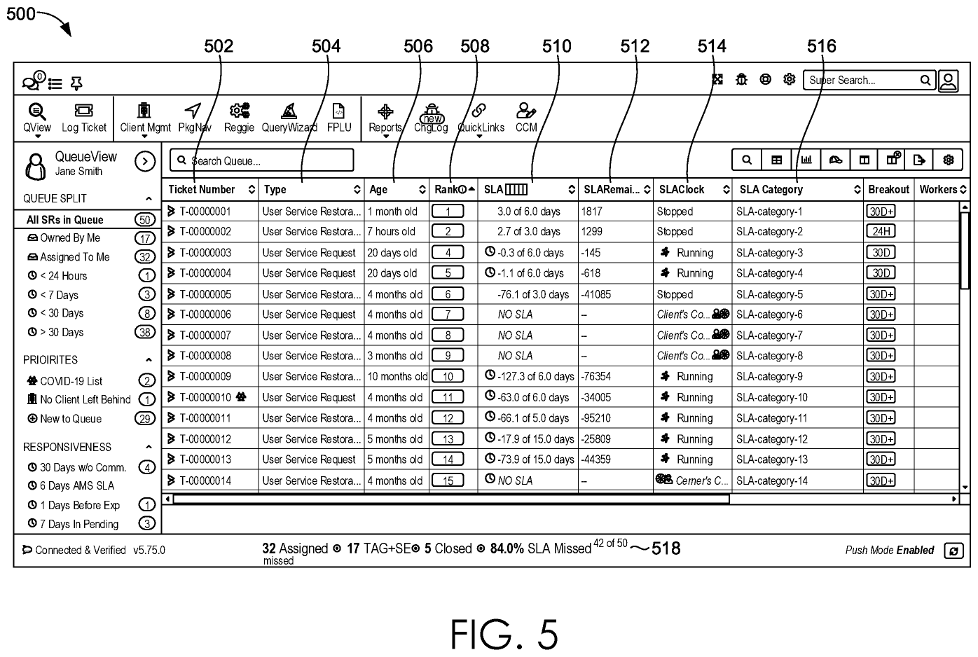

Turning to FIG. 5, an illustrative screen display 500 of a user interface populated by the prioritization engine is depicted, in accordance with embodiments of the present invention. As illustrated, the user interface may display a number of tickets assigned to a user. Each ticket may have a corresponding ticket identification (ID) 502, a ticket type 504, a ticket age 506, the priority or rank of each ticket 508, SLA information 510, SLA remaining 512, SLA clock 514, an entitlement 516, and the like. Additionally, the user interface displays an aggregate score 518 for the associate. As described herein, the aggregate score 518 informs the prioritization system as to how to dynamically and automatically adjust the priority or rank of each ticket 508 (such as by adjusting the rewards and penalties for the tickets based on KPI performance feedback or other inputs received at the prioritization engine) to ensure the order in which tickets are addressed by an associate will optimize adherence to SLA guidelines across a plurality of clients.

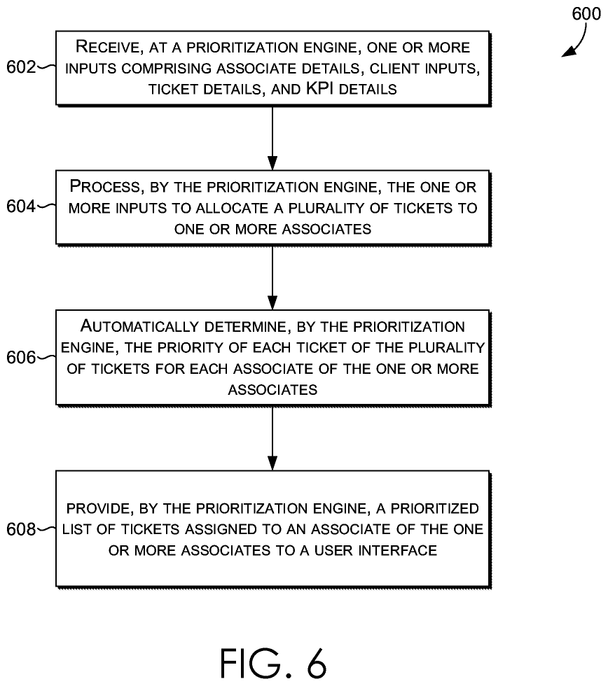

As shown in FIG. 6 a flow diagram is provided illustrating a method 600 for providing service request prioritization, in accordance with various embodiments of the present disclosure. Method 600 may be performed by any computing device (such as computing device described with respect to FIG. 1) with access to a prioritization system (such as the one described with respect to FIG. 2) or by one or more components of the prioritization system (such as the prioritization engine described with respect to FIGS. 2 and 3).

Initially, as shown at step 602, one or more inputs are received at a prioritization engine. The one or more inputs comprise associate details, client inputs, ticket details, and key performance indicator (KPI) details. The one or more inputs correspond to a plurality of tickets in a queue.

At step 604, the one or more inputs are processed by the prioritization engine to allocate the plurality of tickets to one or more associates. The prioritization engine automatically determines, at step 606, the priority of each ticket of the plurality of tickets for each associate of the one or more associates. The prioritization engine provides, at step 608, a list of prioritized tickets assigned to an associate of the one or more associates to a user interface.

In some embodiments, an aggregate score comprising rewards and/or penalties allocated for each ticket of the tickets assigned to the associate may be displayed by the user interface for each associate of the one or more associates. The aggregate score corresponds to an adherence to the priority by the associate for the tickets assigned to the associate. KPI performance feedback may be based on the aggregate score and may be utilized as part of a feedback loop for the prioritization engine. In embodiments, KPI details include KPI performance feedback for the tickets assigned to the associate.

In some embodiments, the KPI details may be adjusted based on the associated details. For example, based on the KPI performance feedback, the prioritization engine may recognize a particular weakness of a particular associate. In order to assist the particular associate in overcoming the particular weakness, the prioritization engine may dynamically adjust rewards and penalties attached to tickets allocated to the associate.

In some embodiments, the KPI details may be adjusted based on the client inputs. For example, based on the KPI performance feedback, the prioritization engine may recognize a deterioration in a particular KPI objective for a particular client. In order to ensure the particular KPI objective does not decrease below a particular threshold for the particular client, the prioritization engine may dynamically adjust rewards and penalties attached to tickets corresponding to the particular KPI objective for the particular client.

As can be understood, the present invention provides systems, methods, and user interfaces for providing regulatory document analysis with natural language processing. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

We claim:

1. A method comprising:
receiving, at a prioritization engine, one or more inputs comprising associate details, client inputs, ticket details, and key performance indicator (KPI) details, the one or more inputs corresponding to a plurality of tickets in a queue;
processing, by the prioritization engine, the one or more inputs to allocate the plurality of tickets to one or more associates;
automatically determining, by the prioritization engine, the priority of each ticket of the plurality of tickets for each associate of the one or more associates; and
providing, by the prioritization engine, a prioritized list of tickets of the plurality of tickets assigned to an associate of the one or more associates to a user interface.

2. The method of claim 1, further comprising dynamically adjusting KPI details based on KPI performance feedback for the tickets assigned to the associate.

3. The method of claim 2, further comprising determining the KPI performance feedback based on an aggregate score, the aggregate score comprising rewards and/or penalties allocated for each ticket of the tickets assigned to the associate.

4. The method of claim 3, further comprising displaying, at the user interface, the aggregate score for each associate of the one or more associates.

5. The method of claim 3, wherein the aggregate score corresponds to an adherence to the priority by the associate for the tickets assigned to the associate.

6. The method of claim 1, further comprising dynamically adjusting KPI details based on the associate details.

7. The method of claim 1, further comprising dynamically adjusting KPI details based on the client inputs.

8. One or more computer storage media having computer-executable instructions embodied thereon that, when executed by a computer, causes the computer to perform operations comprising:
receiving, at a prioritization engine, one or more inputs comprising associate details, client inputs, ticket details, and key performance indicator (KPI) details, the one or more tickets corresponding to a plurality of tickets in a queue;
processing, by the prioritization engine, the one or more inputs to allocate the plurality of tickets to one or more associates;
automatically determining, by the prioritization engine, the priority of each ticket of the plurality of tickets for each associate of the one or more associates; and
providing, by the prioritization engine, a prioritized list of tickets to an associate of the one or more associates to a user interface.

9. The media of claim 8, further comprising dynamically adjusting KPI details based on KPI performance feedback for the tickets assigned to the associate.

10. The media of claim 9, further comprising determining the KPI performance feedback based on an aggregate score, the aggregate score comprising rewards and/or penalties allocated for each ticket of the tickets assigned to the associate.

11. The media of claim 10, further comprising displaying, at the user interface, the aggregate score for each associate of the one or more associates.

12. The media of claim 10, wherein the aggregate score corresponds to an adherence to the priority by the associate for the tickets assigned to the associate.

13. The media of claim 8, further comprising dynamically adjusting KPI details based on the associate details.

14. The media of claim 8, further comprising dynamically adjusting KPI details based on the client inputs.

15. A system comprising:
one or more processors; and
a non-transitory computer storage media storing computer-useable instructions that, when used by the one or more processors, cause the one or more processors to:
receive one or more inputs comprising associate details, client inputs, ticket details, and key performance indicator (KPI) details, the one or more tickets corresponding to a plurality of tickets in a queue;
process the one or more inputs to allocate the plurality of tickets to one or more associates;
automatically determine the priority of each ticket of the plurality of tickets for each associate of the one or more associates; and
provide a prioritized list of tickets assigned to an associate of the one or more associates to a user interface.

16. The system of claim 15, further comprising dynamically adjusting KPI details based on KPI performance feedback for the tickets assigned to the associate.

17. The system of claim 16, further comprising determining the KPI performance feedback based on an aggregate score, the aggregate score comprising rewards and/or penalties allocated for each ticket of the tickets assigned to the associate.

18. The system of claim 17, further comprising displaying, at the user interface, the aggregate score for each associate of the one or more associates.

19. The system of claim 17, wherein the aggregate score corresponds to an adherence to the priority by the associate for the tickets assigned to the associate.

20. The method of claim 15, further comprising dynamically adjusting KPI details based on one or more of the associate details or the client inputs.
